(19) United States
(12) Patent Application Publication
(10) Pub. No.: US 2009/0133886 A1
(43) Pub. Date: May 28, 2009

(54) DISPOSABLE FIRE HOSE FOR FIGHTING STARTING FIRES

(75) Inventor: Edward Jacob Jan Van Noord, Vinkeveen (NL)

Correspondence Address: LAUBSCHER & LAUBSCHER, P.C., 1160 SPA ROAD, SUITE 2B, ANNAPOLIS, MD, 21403, US

(73) Assignee: STICHTING TRANSYLIA, Curacao (AN)

(21) Appl. No.: 12/160,656

(22) PCT Filed: Jan. 18, 2007
(86) PCT No.: PCT/NL2007/000015

§ 371 Date: Oct. 23, 2008

(30) Foreign Application Priority Data
Jan. 19, 2006 (NL) NL 1030955

(51) Int. Cl. A62C 35/20

(52) U.S. Cl. 169/51; 137/355.28; 169/91; 137/799

(57) ABSTRACT

The invention relates to a device executed as small fire-hose (1), which is made of plastic material, such as e.g. polyethylene foil, at its one extremity having a coupling bag (3) for connection to any type of draw-off point (2, 14) of the water supply and preferably at its other extremity being provided with a nozzle (7) fastened to it, disposable fire-hose (1) and coupling bag (3) having a flat cross-section in its non-use condition and having an approximately circular cross-section in its using condition or water-filled condition, as a result of which the disposable fire-hose (1) can be stored in a very compact way when in its non-use condition and is extremely cost-effective due to its material and can be disposed of after use, if necessary.

The invention relates to a device comprising a small fire-hose for household use and being designed as a disposable article that can be mounted in a house on various locations in the vicinity of a draw-off point of the water supply, such as in the kitchen, bathroom, bedroom, attic with washbasin, etc., in order to enhance the safety in a residential building during starting fires, said device also being applicable in workshops, offices, and the like.

Foam extinguishers are known to be available for immediately fighting small fires arisen in a house, office, trailer, boat, workshops, and the like, but these foam extinguishers are relatively expensive and should be checked regularly on their proper functioning. Especially the latter, regular checking, often remains undone, as a result of which the starting fire can not be fought due to failing or poorly functioning of the foam extinguisher, which will mostly lead to a dangerous situation, especially if one should try to escape from a space. Shortly, in practice, and mainly in residential buildings, there are several objections to protecting individuals and goods using only foam extinguishers.

Further, German Offenlegungsschrift DE 10 106 663 A1 discloses an extinguishing device comprising a flat, folded-up hose of approximately 12 m in length in a casing and having at its one extremity a rapid coupling (Gardena system for garden hose) with a professional valve at the water supply and having at its other extremity, again a rapid coupling, (Gardena system), connected to a nozzle from e.g. the same Gardena series.

It is a disadvantage, that this requires a voluminous casing of 30×30×8 cm and a professional valve at the water supply, which represents a considerable interference to the interior of the home and provides a less attractive whole. Additionally, putting back the hose—which can not be emptied completely—after use, is hardly practicable. Thus, this extinguishing device is unsuitable as disposable fire extinguishing equipment, since it has too many parts which are too valuable to be disposable and the equipment is too complicated for the unskilled user to use quickly in panic situations.

Further, Spanish PCT/ES2004/000052 describes a portable household fire fighting device that can be secured to the draw-off point of the water supply through a tubular body having an internal pneumatic cushion and/or that can be secured to the draw-off point at the other side by means of an inner threading and can then be coupled to a hose (not illustrated) by one of both extremities of the device described. Said pneumatic cushion should be inflated by a pump through a connecting pipe.

The whole is absolutely not workable for use by an amateur being in panic, and additionally, the garden hose should be close at hand. Thus, this is unsuitable for use as a cost-effective disposable article and can not be easily stored on any location.

The object of the present invention is to provide such a device for fighting starting fires, especially in residential and working environments, that does not have the previously described objections and which device can be put on the market as a disposable article at a low price.

To this end, a device designed as a disposable fire-hose with accessories according to the invention is characterized in that in its non-use condition, the small disposable fire-hose is a flat, collapsible hose having a length L and having at least at its one extremity a facility for connection to said draw-off point of the water supply.

The advantage is a more effective disposable fire-hose, which can be purchased at a low price and thus can be mounted in any space near a draw-off point of the water supply.

Further, the device according to the invention is characterized in that said facility at one extremity of the small disposable fire-hose is a coupling bag for enclosing any type of draw-off point, which can be secured behind said draw-off point by a waterproof sealing ring with pulling cords, said coupling bag being sealed to the disposable fire-hose or being secured through a hose clip, the other extremity of said small disposable fire-hose being provided with a nozzle, secured to the disposable fire-hose by e.g. a hose clip or being sealed to it.

The advantages are a quickly mountable small fire-hose, that will effectively fight a starting fire by means of a powerful jet and thus allowing for a considerable enhancement of the safety of individuals and goods in a space, such as a house or office.

Further, the device according to the invention is characterized in that said disposable fire-hose is made of plastic material, such as e.g. polyethylene foil, the disposable fire-hose being a flat hose in its non-use condition and taking up the approximately round or circular cross-section in its using condition or inflated condition.

The advantage is a disposable fire-hose that can be stored as a small package.

Hereinafter, the invention is further explained by way of an embodiment illustrated in the drawing. Therein:

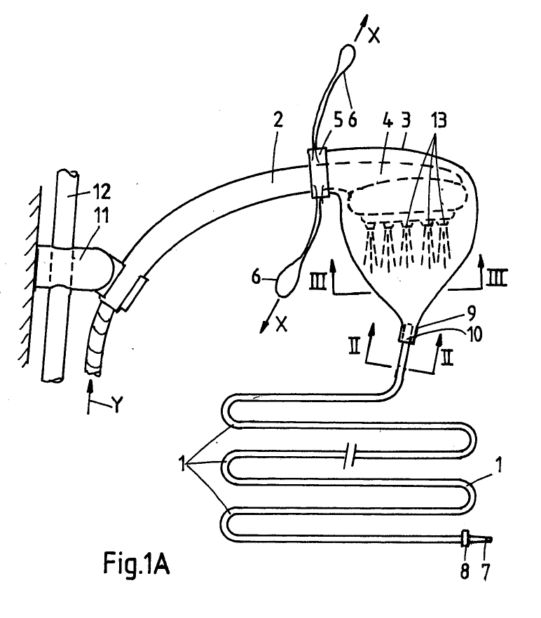

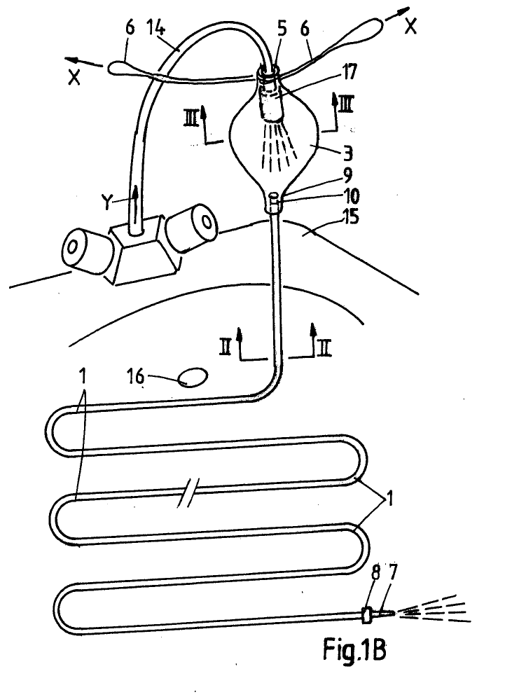

FIGS. 1A and 1B illustrate a lateral view and a perspective view, respectively, of the disposable fire-hose according to a preferred embodiment of the invention, being fastened to a modern shower head (FIG. 1A) and a washbasin tap (FIG. 1B), respectively;

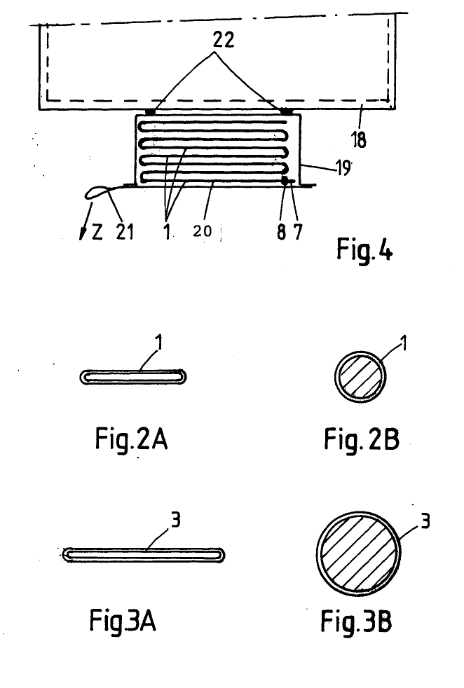

FIGS. 2A and 2B illustrate a cross-section according to line II-II of FIGS. 1A and 1B, in which the fire-hose is empty (FIG. 2A) or filled with water during use (FIG. 2B);

FIGS. 3A and 3B illustrate a cross-section according to line III-III of FIGS. 1A and 1B, the coupling bag of the disposable fire-hose being empty (FIG. 3A) or filled with water during use (FIG. 3B); and

FIG. 4 illustrates a cross-section of a storage box for fastening to a washbasin, kitchen cabinet, etc., the disposable fire-hose with accessories being stored in said storage box.

FIG. 1A illustrates a lateral view of the disposable fire-hose 1 which is fastened to a modern shower head 2. The disposable fire-hose 1 has one extremity provided with coupling bag 3 for positioning across the actual adjustable water jet element 4. Through a connecting strap 5, said coupling bag 3 is provided with pulling cords 6, which are pulled in arrow direction X, with a waterproof connection to shower head 2. Said pulling cord 6 comprises a rubber string having a cross-section of 4×10 mm with a corrugated surface, said cords extending through stainless steel M5 rings in said coupling bag 3. After releasing the pulling cords 6, the rubber string expands and locks the coupling bag around the valve neck of said draw-off point 2, 14. The other extremity of the disposable fire-hose 1 is provided with a nozzle 7, possibly being secured to the disposable fire-hose 1 by a hose clip 8. The connection between disposable fire-hose 1 and the coupling bag 3 can also be effected with an inserted tube 9 and a hose clip 10. The shower head 2 is secured to a vertical stationary rod 12 by means of a vertically adjustable coupling element 11 in the usual way. Water flows to the outlet openings 13 of adjustable water jet element 4 according to arrow Y. Due to its dimensions, said coupling bag 3 can be connected to any conventional water tap.

FIG. 1B illustrates a perspective view of the disposable hose 1 according to the preferred embodiment of the invention, which is fastened to a washbasin tap 14, having washbasin 5 provided with overflow connection 16. At its outlet opening, washbasin tap 14 is provided with a thickened jet breaker 17. For disposable fire-hose 1 with accessories, the same position numbers as in the description of FIG. 1A were maintained.

FIGS. 2A and 2B illustrate a cross-section of the disposable fire-hose 1 according to line II-II in FIGS. 1A and 1B. In FIG. 2A, the fire-hose is empty and in FIG. 2B, it is completely filled.

FIGS. 3A and 3B illustrate in a similar way a cross-section of the coupling bag 3 across line III-III of FIGS. 1A and 1B, the coupling bag being empty in FIG. 3A and being completely filled in FIG. 3B.

It can be stated that the disposable fire-hose 1 and the coupling bag 3 are flat in the empty condition and can then be collapsed or rolled-up easily and after that be stored in the storage box of FIG. 4.

FIG. 4 illustrates a cross-section of the storage box 19 for fastening to the bottom of a washbasin, kitchen cabinet 18, and the like, into which empty disposable fire-hose 1 plus accessories can be easily fitted in rolled-up or collapsed condition. At its bottom, storage box 19 is closed by a sheet of plastic foil 20 and can be opened by pulling a small lip 21 in the direction of arrow Z. With its top, storage box 19 can be fastened to e.g. a kitchen cabinet with pads of double-sided adhesive tape 22. Directions for use, logos and advertisements can be applied on storage box 19. It is also possible to apply a special design for the shape and colouring, and the like, of storage box 19.

Finally, it should be stated clearly that a preferred embodiment of the invention has been described hereinabove, and that obviously further modifications and the like are possible, without falling beyond the scope of this patent.

1. Device comprising a small fire-hose for household use and being designed as a disposable article that can be mounted to a house on various locations in the vicinity of a draw-off point of the water supply, such as in the kitchen, bathroom, bedroom, attic with washbasin, etc., in order to enhance the safety in a residential building during starting fires, said device also being applicable in workshops, offices, and the like, characterized in that in its non-use condition, the small disposable fire-hose (1) is a flat collapsible hose having a length L and having at least at its one extremity a facility for connection to said draw-off point (2, 14) of the water supply.

2. Device according to claim 1, characterized in that said facility at one extremity of the small disposable fire-hose (1) is a coupling bag (3) for enclosing any type of draw-off point (2, 14), which can be secured behind said draw-off point by a waterproof sealing ring (5) with pulling cord (6), said coupling bag (3) being sealed to the disposable fire-hose or being secured to it by a hose clip (10).

3. Device according to claim 1, characterized in that the other extremity of said small disposable fire-hose (1) is provided with a nozzle (7), secured to the disposable fire-hose (1) by e.g. a hose clip (8) or is sealed to it.

4. Device according to claim 1, characterized in that said length L is between 2 and 20 mm, preferably approximately 10 m.

5. Device according to claim 1, characterized in that said disposable fire-hose (1) is made of plastic material, such as e.g. polyethylene foil, the disposable fire-hose (1) being a flat hose in its non-use condition and taking up the approximately round or circular cross-section in its using condition or inflated condition.

6. Device according to claim 3, characterized in that the cross-section of the discharge end of the nozzle (7) is between 20 to 50 percent of the filled round cross-section of the disposable fire-hose (1), and is preferably 30 percent.

7. Device according to claim 1, characterized in that in its non-use condition, said small disposable fire-hose (1) with accessories is stored in a storage box (19) for fastening to e.g. the bottom of a washbasin, kitchen cabinet (18), and the like, in which said storage box (19) has been fastened e.g. with pads of double-sided adhesive tape (22).
